(19) United States
(12) Patent Application Publication
(10) Pub. No.: US 2004/0162898 A1
(43) Pub. Date: Aug. 19, 2004

(54) Dedicated networked device monitoring system

(76) Inventor: Jason H. Rich, Aurora, CO (US)

Correspondence Address: COCHRAN FREUND & YOUNG LLC, 3555 STANFORD ROAD, SUITE 230, FORT COLLINS, CO, 80525, US

(21) Appl. No.: 10/776,496

(22) Filed: Feb. 10, 2004

Related U.S. Application Data
(60) Provisional application No. 60/448,181, filed on Feb. 14, 2003.

(51) Int. Cl. G06F 15/173

(52) U.S. Cl. 709/224

(57) ABSTRACT

A dedicated networked device monitoring system that enables a user to create, download and store customized tests to a dedicated networked device monitor connected to networked devices. The dedicated networked device monitor may perform repeated tests on the devices, determine if the devices are functioning correctly, and dispatch alerts and control commands if the devices are not functioning correctly. The dedicated monitor performs certain monitor and control functions without delay from computer or network throughput problems. The monitoring system includes the ability to customize and store to a library, network device specific tests that may be reused and applied to different devices through an administrative tool. Further, a control room interface allows the dynamic and graphic representation of many different status items of the networked devices to be created and displayed. The control room allows various commands to be executed to monitor and maintain the networked devices.

### CROSS REFERENCE TO RELATED APPLICATIONS

This application is based upon and claims the benefit of U.S. Provisional Patent Application Serial No. 60/448,181 by Jason H. Rich entitled “Monitoring System” filed Feb. 14, 2003, which is hereby specifically incorporated herein by reference for all that it discloses and teaches.

### BACKGROUND OF THE INVENTION

a. Field of the Invention

The present invention pertains to monitoring systems and specifically to monitoring systems capable of monitoring networked devices.

b. Description of the Background

Monitoring systems are crucial tools in businesses where electronic equipment must be on-line and functioning for extended periods.

Several problems exist with existing software monitoring applications. Monitoring applications typically execute in parallel with other tasks, so that the monitoring function may be slower during periods where the monitoring computer must perform these other tasks. The use of timeouts to determine whether a network device is responding as expected may be hampered by the indeterminate execution time of a network monitoring commands on a heavily loaded host. Slow response time due to loading of intermediate network elements may further inhibit accurate and timely monitoring. Also, the monitoring computer may be vulnerable to viruses or hacker attacks. Further, a software monitoring system may operate on a computer system with an operating system that has many recurring updates and patches, which may cause the monitoring system to function incorrectly until an update to the monitoring system can be installed.

Some existing monitoring systems do not notify a person of a network issue in a timely manner. Failure to promptly detect and correct a networked device error condition can be extremely expensive and in some applications life-threatening.

Moreover, existing software monitoring systems are limited in their ability to correct problems. For example, software commands may be issued by a monitoring system to restart a computer. In cases where the operating system is stuck and cannot execute a restart command, the power to the computer must be physically cycled which cannot be done by the monitoring system. Rather, a local technician physically press a hardware reset switch on the device.

### SUMMARY OF THE INVENTION

The present invention overcomes the disadvantages and limitations of the prior art by providing a dedicated networked device monitoring system and method for monitoring a group of networked devices wherein a monitoring unit may repeatedly perform various tests of the devices, dispatch various types of status/control messages, and provide a monitoring function to send monitoring data and easily access the control of the devices. The inventive system and method includes a library of standardized tests as well as a scripting function that allows customized tests to be created. The library of tests may be applied to different devices and parameters for each test may be set for each device. An application specific control room system of graphical objects may be created and displayed on a screen and have real time updates and interactivity.

The present invention may therefore comprise a dedicated networked device monitor comprising: a network connection; a first processor that stores, sends, and receives messages over the network connection, sends customized test messages to the networked devices and receives test results from the networked devices, the first processor capable of analyzing the test results and sending control/status messages if the test results meet a predetermined criteria, the first processor further capable of storing the test results, receiving a query from a control computer, and transmitting the test results to the control computer; at least one switchable power outlet; and a second processor adapted to receive a power cycle command from a first processor and turn off the switchable power outlet based on the power cycle command.

The invention may further comprise a monitoring system for monitoring networked devices comprising: a network; at least one networked device that is connected to the network; a control computer that is connected to the network; a dedicated networked device monitor having a first processor and a second processor, the first processor adapted to store, send, and receive test messages and control commands over the network connection and to receive, and analyze test results from the networked devices, the first processor further capable of sending messages to and receiving messages from a control computer and transmitting the test results to the control computer, and sending power cycle commands and other messages to the second processor connected to at least one switchable power outlet and capable of switching the switchable power outlet based on the power cycle commands; an administration computer that is connected to the network, the administration computer comprising software that it capable of creating, defining and storing network device diagnostic tests to a test library, the administration computer further comprising software to select the tests from the library, assign the tests to the networked devices, and transmit the tests to the first processor; and control room builder software that is capable of creating customized control room graphical displays to display said test results and storing said displays to run on said control computer.

The invention may further comprise a method of monitoring networked devices comprising: providing a dedicated networked device monitor that can receive and storing networked device tests and can send tests and control messages to said networked devices and receive and processor test results from the networked devices, the dedicated networked device monitor having switchable power outlets and being capable of switching the outlets; connecting the dedicated networked device monitor through a network connection to the networked devices; connecting a power connection of the networked devices to the switchable power outlets of the dedicated networked device monitor; providing a control computer having control room creation and display software, the control computer capable of sending messages to and receiving messages from the dedicated networked device monitor; communicating with the dedicated networked device monitor through a network connection using the control computer; monitoring test results from the networked devices; processing the test results; and sending control commands to the dedicated networked device monitor if the test results meet a specified criteria.

The advantages of the present invention are that several networked devices may be monitored and controlled remotely by a dedicated networked device monitoring system. Software allows users to create and store in a library device specific tests and commands that are downloaded to the dedicated networked device monitor. Control room builder software provides application specific customized displays that can be deployed on a control computer or handheld device that communicates over a network to the monitor. In addition to software based reset commands, a switch is provided for cycling power of the device. A dedicated monitor may include software and hardware features that make it resistant to virus or other hacker attacks, and to disruptions due to intermediate network elements. Encrypted communications between the monitor and any controlling device further protect the system from disruption.

### BRIEF DESCRIPTION OF THE DRAWINGS

In the drawings,

FIG. 1 is an illustration of an embodiment of a monitoring system.

FIG. 2 is a more detailed diagram of an embodiment of a monitoring system.

FIG. 3 is a workflow diagram of a monitoring system

FIG. 4 is a workflow diagram of the administrative software.

FIG. 5 is an illustration of an embodiment of network monitoring system wherein several monitors are used to monitor several devices.

FIG. 6 is an illustration of an embodiment of a control room display of a network monitoring system.

### DETAILED DESCRIPTION OF THE INVENTION

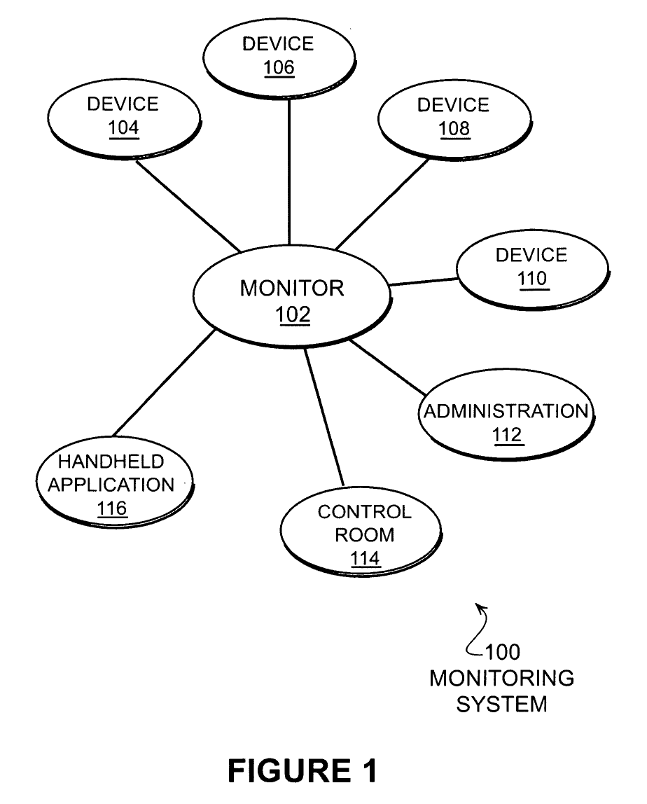

FIG. 1 illustrates an embodiment of a dedicated networked device monitoring system 100. A monitor 102 is connected to devices 104, 106, 108, and 110. The monitor 102 is further connected to an administration module 112, control room 114, and a handheld application 116.

The devices 104, 106, 108, and 110 may be any type of networked device, such as computers, medical devices, process controllers, or any other type of device that is able to communicate over the network. For example, the devices 104, 106, 108, and 110 may be computer servers. The monitor 102 may be located in physical proximity to the devices 104, 106, 108, and 110 so that the monitor 102 may be able to switch off the power to the servers. Co-location of the monitor 102 and the monitored devices 104, 106, 108, and 110 provides a timely and consistent response time by eliminating intermediate network elements. In other embodiments, the monitor 102 may be located remotely from the various devices.

The monitor 102 may be capable of continuously checking the status of various items, such as performance parameters of the devices, proper functioning of various portions of the devices, or the results of processes being performed by the devices.

In the example of a monitor of a computer server, the monitor 102 may check memory usage, processor load, or other parameters relating to the server performance. The monitor 102 may send test queries to various programs or software elements that are operational on the server to check if the programs are properly functioning. Further, the monitor 102 may collect data relating to the number of processed transactions, for example, the dollar volume of bank transactions, or other results.

In other embodiments, the devices 104, 106, 108, and 110 may be healthcare monitoring devices. The monitor 102 may check that the devices are on line and that various functions of the devices are properly functioning. In addition, the monitor 102 may collect data relating to patients to which the devices may be attached.

The administration module 112 may allow for configuration of the various parameters of the monitor 102, such as determining protocols, creating tests, and other administrative functions.

A control room module 114 may provide a means for retrieving data from the monitor 102 and for sending commands to the monitor 102. The control room module 114 may provide some of the same functions as the administration module 112.

The handheld application 116 may be a reduced version of the control room module 114 that allows for a wireless monitoring and control of the monitor 102 using a handheld computer. Other types of portable interfaces such as infrared or wired connections may be used.

Those skilled in the art will appreciate that the number of devices that a monitoring system may monitor is not limited. For some embodiments wherein the testing and reporting requirements are severe, the ratio of monitors to devices being monitored may be one-to-one. In other embodiments, a single monitor may monitor thousands of devices.

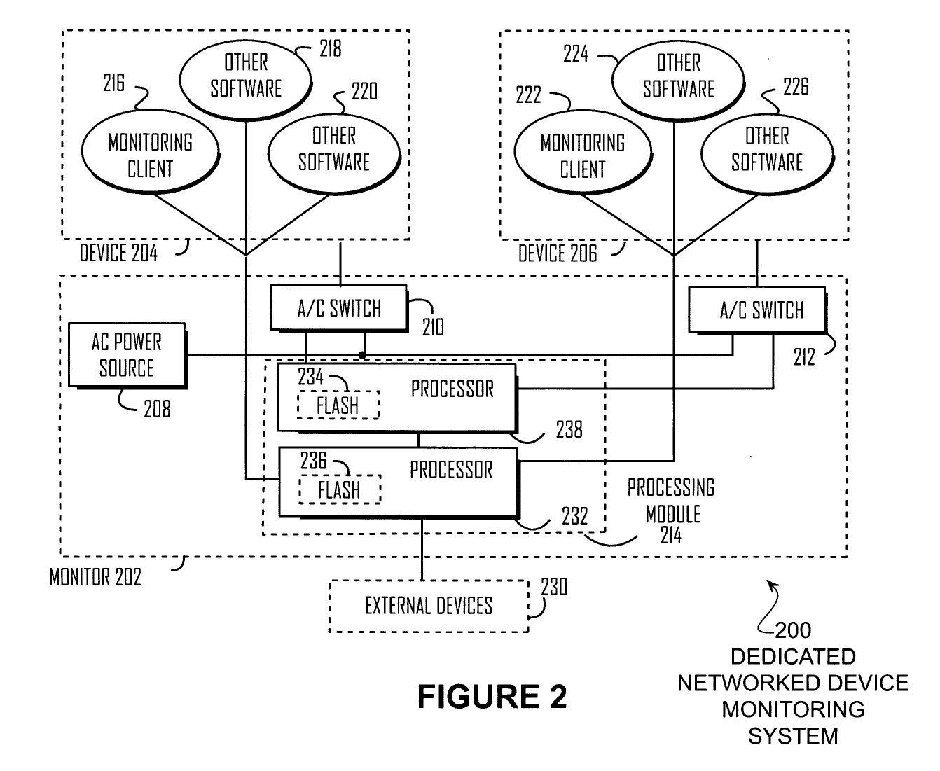

FIG. 2 illustrates a diagram of an embodiment 200 of a dedicated networked device monitoring system. The monitor 202 is connected to devices 204 and 206. An alternating current power source 208 is connected to the devices 204 and 206 through AC switches 210 and 212. The AC switches may be the sole source of power to the devices 204 and 206. The AC switches 210 and 212 may be controllable by a processing module 214. In one embodiment illustrated, the processing module 214 includes a first processor 232 and second processor 238. In other embodiments, where cost reduction is desired and physical processor redundancy that provides fault tolerance is not required, the processing module may comprise a single physical processor that includes a first processor 232 and a second processor 238 wherein the first processor and the second processor are virtual processor modules such as may be used with real-time operating systems. Likewise, the first processor 232 and the second processor 238 may each comprise a plurality of physical processors sufficient to provide the needed processing power for a particular application.

The first processor 232 communicates with a second processor 238. The first processor 232 communicates through a network or other communication path to device 204 to interact or communicate with a monitoring client 216 and other software components 218 and 220. Likewise, the first processor 232 communicates through a network or other communication path to device 206 to interact or communicate with a monitoring client 222 and other software components 224 and 226. The first processor 232 may be connected to external devices 230. The first processor 232 acts as a network firewall to the second processor 238. Both the first processor 232 and the second processor 238 may contain embedded program memories that are non-volatile memories such as flash memories 234 and 236. However, any desired type memory may be used. Certain portions of the non-volatile memories may be configured to be locked so that the programs contained therein may not be altered. Locked programs, in the first processor 232 and the second processor 238, that cannot be altered by network commands, provide a more stable system because they are resistant to errors due to operating system upgrade problems, virus attacks, hacker attacks, corruption due to power failure, etc. Further, the delay from power on to fully operational monitoring and control for the monitor 202 is much less than the typical operating system boot up delay and subsequent loading of PC based monitoring software. Thus, in the case of a prolonged power failure, the monitoring system may monitor slow booting devices such as servers during the power on reboot period.

The AC switches 210 and 212 may be controlled by the second processor 238. In many cases where the monitor 202 may be located remotely from the user who is monitoring and controlling the system, the AC switches 210 and 212 may be activated to shut down and/or restart the devices. Such action may be necessary, for example, when the device has a problem such that it cannot respond to any other commands or when a software command is ineffective. As described above, the monitor 202 may monitor or control devices immediately following a restart without delays from intermediate network elements or system boot up delays.

The monitoring client 216 may be a program that operates on the device 204 and is able to perform various querying functions of the device 204. For example, the monitoring client 216 may be capable of gathering information regarding the performance of the device, such as memory loads or traffic loads in the case of a computer server. Further, the monitoring client 216 may be capable of executing commands such as shut down, restart, killing certain processes, or performing other operations necessary for administering the device.

The monitoring client 216 may have special administrative powers that may allow it to control important functions of the device 204. As such, the communications between the monitor 202 and the monitoring client 216 may be encrypted or otherwise made secure in some embodiments. In the same manner, communications between the monitor 202 and any external devices 230 may be encrypted.

The first processor 232 may communicate with other software programs 218 and 220 using various mechanisms. For example, the first processor 232 may send a simple query to the software 218 and analyze the returned data to ensure that the software 218 is properly functioning. If the software 218 was a web server, the first processor 232 may send a request for a specific web page to the software 218. The response may be a particular web page with a text string that can be compared or analyzed by the first processor 232 to determine that the software 218 is properly functioning. If the software 218 does not respond, or responds incorrectly, it may indicate that the software 218 needs the attention of a technician.

The external devices 230 may be any device that is capable of communicating with the monitor 202 in one or two directions, such as a computer, pager, wireless or terrestrial telephony device, or any other electronic communications device that can be conceived. In some embodiments, a remotely located computer may be used to send commands to and receive transmissions from the monitor 202.

Those skilled in the art will appreciate that several configurations may be possible while keeping within the spirit and intent of the present invention.

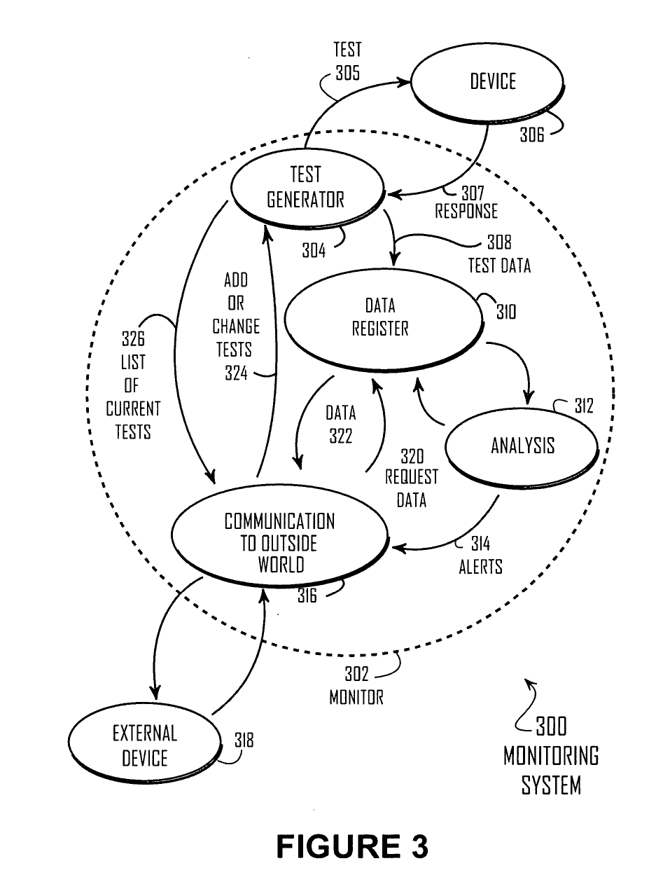

FIG. 3 illustrates a work flow diagram of an embodiment of a monitoring system 300. The monitor 302 contains a test generator 304 that sends tests 305 to a monitored device 306. The device 306 returns a response 307 to the test generator 304. The test data 308 may be placed in a data register 310. An analysis program 312 may analyze the data in data register 310 and issue alerts 314 if specific conditions exist. An alert may be transmitted to an external device 318 through a communications routine 316. The communications routine 316 may handle requests from an external device 318 to request data 320 from the data register 310. The data 322 may be transmitted to the external device 318. Further, the external device 318 may transmit added or changed tests 324 to the test generator 304 and retrieve lists of current tests 326.

The test generator 304 may perform various tests on the device 306. The tests may include sending a query string and receiving a response, issuing a command and receiving a response, or any type of test and control that one may conceive. The test generator 304 may perform tests repeatedly depending on the application.

The data register 310 may include current data and historical data. In some embodiments, the data register 310 may only include the most current test results. In other embodiments, a historical record of several executions of a test may be kept in the data register 310.

The monitor 302 may include separate processes that run simultaneously for the test generator 304, the analysis 312, and the communication 316. Such processes may be operable on a single processor. In other embodiments, one or more additional processors may handle various portions of the functionality. For example, one processor may be dedicated to the test generator 314 process while another processor is dedicated to the analysis function 312. Those skilled in the art may use various software and hardware architectures to perform the various functions of the monitor 302 while keeping within the spirit and intent of the present invention.

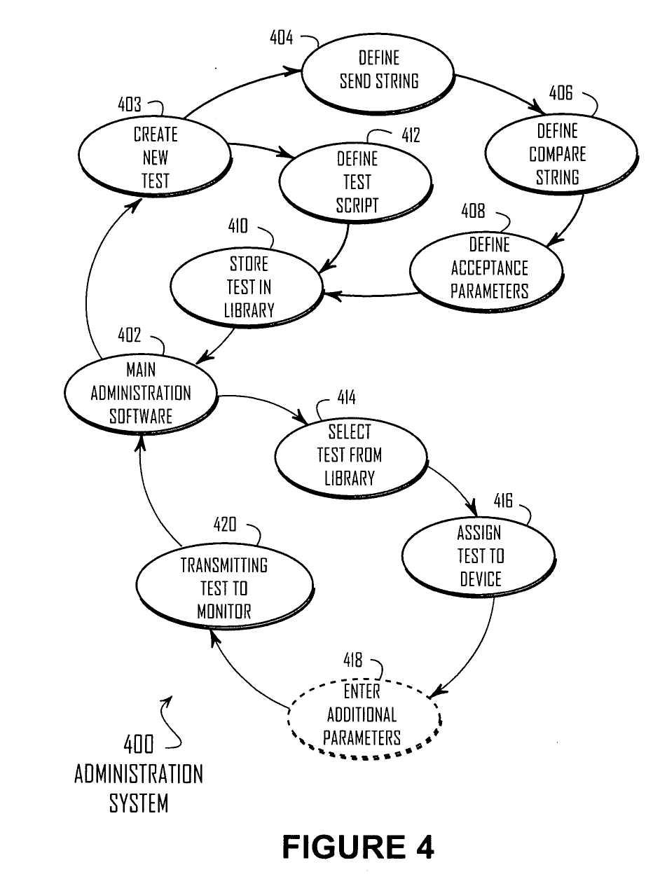

FIG. 4 illustrates a workflow diagram of an embodiment 400 of the administrative software. From the main routine 402, a new test may be created 403. The new test may be created by defining a send string 404, a compare string 406, and acceptance parameters 408 before storing the test in a library 410. The user may also define a test script 412 and store the test in a library. When the test is to be implemented, a test is selected from a library 414, assigned to a device 416, and additional parameters may be entered 418 before transmitting the test to a monitor 420 and returning to the main routine 402.

The embodiment 400 illustrates a mechanism for creating and implementing tests for the monitors to run. The tests may be first created and stored in a library, then the test may be assigned to a device with the device-specific information before executing the test.

The tests may consist of sending a specific string to a device and comparing the returned string to a compare string. The pass/fail criteria may also be defined. For example, in a simple test for a web server device, the send string may request a specific web page and the compare string may be an embedded text string that is normally contained in the page. The criteria for the test may be that if the compare string is found inside the returned page, then the test is passed. Such a test may be stored in the library.

When the test is assigned to a device, the device address, port number, and other device-specific parameters may be assigned and the test would then be operable. If the same test is to be assigned to a second device, only the device-specific parameters would need to be assigned and the test would be operable for the second device as well.

The library of tests allows tests to be reused over many devices without having to reprogram each test. As tests become more complex and are defined by elaborate scripts and complex analysis techniques, the library of tests makes the administration functions of the monitors less tedious and complex.

The library of tests ensures that standardized tests are used across the various devices. In the example of a web server device, there are often several web servers operating in parallel for both throughput and redundancy. These devices may all use the same basic battery of tests.

The library of tests may be stored in the monitor in non-volatile memory. A library of tests wherein the tests are assigned to specific devices with device-specific information uses the memory storage of the monitor more efficiently. Thus, more tests may be executed on more devices with the same amount of memory.

The library of tests may also be stored in an administrative computer that is capable of administering many different monitors. In such an embodiment, similar tests may be used over many monitors without tediously re-entering the test routines for each device.

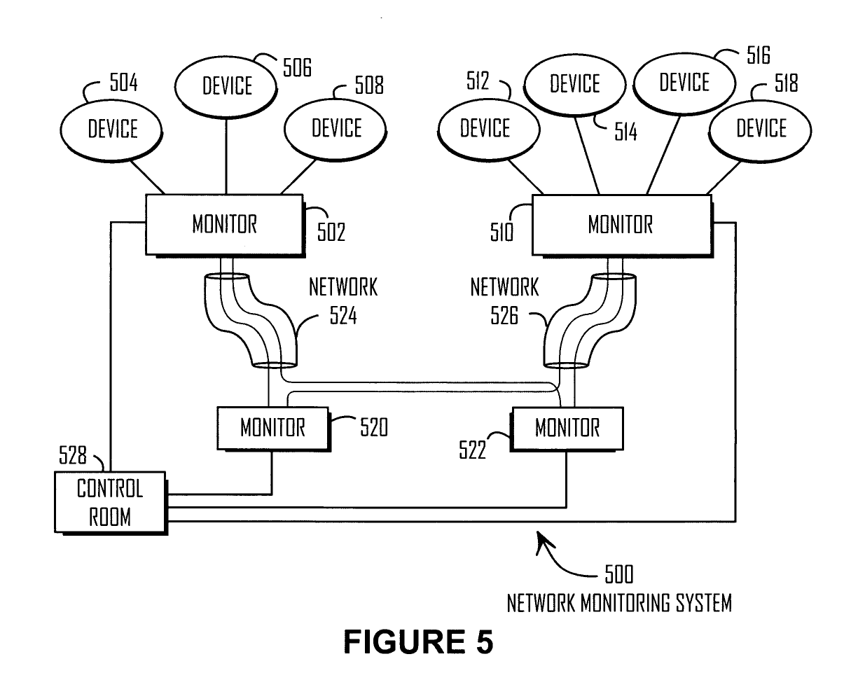

FIG. 5 illustrates an embodiment 500 of network monitoring system wherein several monitors are used to monitor several devices. Monitor 502 is locally connected to devices 504, 506, and 508. Monitor 510 is locally connected to devices 512, 514, 516, and 518. Monitors 520 and 522 are located remotely and are able to monitor the devices as well as the monitors 502 and 510 through the networks 524 and 526. The control room 528 is connected to all of the monitors 502, 510, 520, and 522 and may be located remotely to any of the monitors.

The monitors 502 and 510 may be located locally with the various devices. The monitors 502 and 510 may be capable of switching the power to the devices on and off and thereby performing a hard reset of the devices. The monitors 502 and 510 may also perform regular status tests and be capable of communicating with a client monitoring application that may be running on the devices.

The monitors 520 and 522 may be used to perform status checks on the network performance to determine if there are other network bottlenecks that may be prohibiting the devices from operating properly. For example, if the throughput of one or more devices is very low, a problem may exist on the network that communicates with the device. In such a case, the monitors 520 and 522 may send periodic tests over the networks and measure the response time or have other measures of the network.

The remote monitors 520 and 522 may be used to perform periodic tests on the local monitors 502 and 510. The remote monitor 520, for example, may send a periodic test to monitor 520 to ensure that monitor 502 is properly functioning. Any of various aspects of the monitor 502 may be checked or evaluated on a periodic basis. Such an arrangement may be useful when redundancy of the monitoring system is desired. The remote monitors 520 and 522 may perform all or some of the same tests as the local monitors 502 and 501.

In one embodiment, the control room 528 may be a computer running a control room application that collects and displays data from the various monitors. In other embodiments, the control room 528 may be a personal digital assistant, e.g. PDA, or other handheld device running a control room application. The control room 528 may further allow a user to actuate various functions of the monitors, including sending commands to the monitors or the devices.

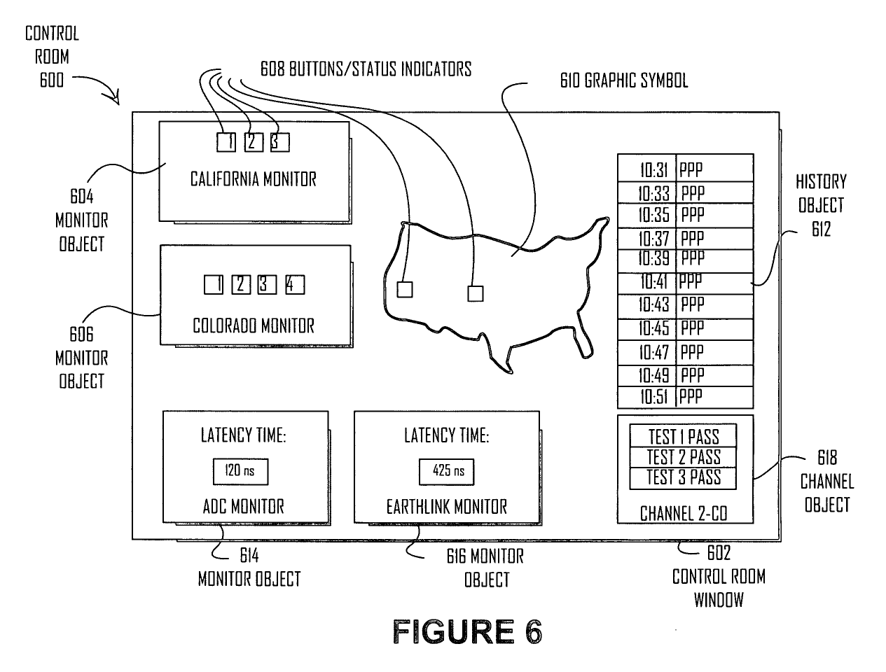

FIG. 6 illustrates an embodiment 600 of a control room application as may be applicable to the monitoring system of FIG. 5. The control room window 602 may be a display on a computer screen. Monitor objects 604 and 606 may represent the monitors 502 and 510 of FIG. 5. The monitor objects 604 and 606 may contain buttons or indicators 608. A graphic symbol 610 may also contain buttons or indicators 608. A history object 612 collects and displays past results from various items. A second type of monitor objects 614 and 616 may be used for the monitors 520 and 522 of FIG. 5. A channel object 618 may be used to monitor a specific device.

The control room embodiment 600 represents a user interface that may display the status of various parameters of the system in real time or near real time. Each object may be a separate routine that performs a specific task. For example, the monitor object 604 may periodically send a query to the monitor 502 and request the status of the devices. The status of the devices may be attached to the buttons 608. In some embodiments, the color of the button may change from green to red if a status bit changes. In other embodiments, an audio alert may be triggered, the button shape may change, or the text within the object 604 may change.

The buttons 608 may be used for indicating status or may also be used for issuing commands. For example, if a button 608 on the monitor object 604 is actuated, a dialogue box may be presented to allow a user to execute various functions. In the example, the operator may be presented with the choice of restarting the device, changing a setting on the device, requesting a more detailed description of an error, or otherwise execute a command or query. In some cases, actuating a button may perform a command directly without having a dialogue box appear.

The history object 612 may display several responses for specific tests over time. In some embodiments it may be advantageous to collect and display a result in a time series. For example, in some cases, the pass/fail results of specific tests might be displayed. In another example, the memory loading or other performance parameter may be displayed over time. In the former example, the display may be a color-coded table of green and red blocks that are updated periodically. In the latter example, a graph may be used to display the results. Such history objects may be useful visual indicators of specific parameters.

The monitor objects 614 and 616 may display the results of one specific test that is performed periodically. The results may be displayed in numerical form, in a graphical form, a combination of numerical and graphical, or other methods.

The channel object 618 may be an object that displays the results of tests that are performed on one device. The user may be able to configure the channel object to display the results from one or more tests performed on the device.

Each object on the control room window 602 may be capable of issuing an alarm. For example, the monitor object 614 may have a threshold setting wherein if a parameter exceeds that threshold, the object may cause an alert to execute. The alert may be in the form of a change to the control room window 602, such as a dialogue box, or may include other forms of communication. Other forms of communication may include audible alerts, actuating a flashing light, sending an email, placing a voice call, paging, or causing some other action or routine to execute such as an automatic shutdown or other action.

The various objects on the control room window may be movable and configurable by dragging and dropping with a cursor. For example, a history object may be selected from an icon tray, menu, or other mechanism and dragged onto the control room window 602. The history object may be positioned and resized using a cursor by dragging various handles, such as handles for panning or resizing. Parameters for the history object may be entered by actuating a button, menu, keystroke, or other mechanism whereby a dialogue box or other data entry mechanism may appear. The user may then enter various parameters that are required for the history object to function. These parameters may include the network address of the device, a specific test result that is to be displayed, the actions associated with any buttons or other active areas of the object, as well as other parameters.

The control room may communicate to all of the monitors and devices using encrypted communications. In some embodiments, the control room may be located remotely from the monitors and devices and may communicate over the Internet or other widely accessible communications media. In such cases, the sensitive commands that are capable of shutting down the devices may be protected by encrypting the communications transmissions between the control room and the various monitors and devices.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A dedicated networked device monitor comprising:
a network connection;
a first processor that stores, sends, and receives messages over said network connection, sends customized test messages to said networked devices and receives test results from said networked devices, said first processor capable of analyzing said test results and sending control/status messages if said test results meet a predetermined criteria, said first processor further capable of storing said test results, receiving a query from a control computer, and transmitting said test results to said control computer;
at least one switchable power outlet; and
a second processor adapted to receive a power cycle command from a first processor and turn off said switchable power outlet based on said power cycle command.

2. A monitoring system for monitoring networked devices comprising:
a network;
at least one networked device that is connected to said network;
a control computer that is connected to said network; and
a dedicated networked device monitor having a first processor and a second processor, said first processor adapted to store, send, and receive test messages and control commands over said network connection and to receive, and analyze test results from said networked devices, said first processor further capable of sending messages to and receiving messages from a control computer and transmitting said test results to said control computer, and sending power cycle commands and other messages to said second processor connected to at least one switchable power outlet and capable of switching said switchable power outlet based on said power cycle commands.

3. The system of claim 2 further comprising:
an administration computer that is connected to said network, said administration computer comprising software that it capable of creating, defining and storing network device diagnostic tests to a test library, said administration computer further comprising software to select said tests from said library, assign said tests to said networked devices, and transmit said tests to said first processor; and
control room builder software that is capable of creating customized control room graphical displays to display said test results and storing said displays to run on said control computer.

4. The system of claim 2 wherein said control computer is a handheld device.

5. The system of claim 4 wherein said network connection is a wireless connection.

6. The system of claim 2 wherein said first processor and said second processor include non-volatile memory wherein selected sections of said non-volatile memory may be locked to prevent unauthorized or accidental modification of the contents.

7. The system of claim 2 wherein said messages between said control computer and said monitor are encrypted such that interpretation of said messages requires a decryption key.

8. A method of monitoring networked devices comprising:
providing a dedicated networked device monitor that can receive and storing networked device tests and can send tests and control messages to said networked devices and receive and processor test results from said networked devices, said dedicated networked device monitor having switchable power outlets and being capable of switching said outlets;
connecting said dedicated networked device monitor through a network connection to said networked devices;
connecting a power connection of said networked devices to said switchable power outlets of said dedicated networked device monitor;
providing a control computer having control room creation and display software, said control computer capable of sending messages to and receiving messages from said dedicated networked device monitor;
communicating with said dedicated networked device monitor through a network connection using said control computer;
monitoring test results from networked devices;
processing said test results; and
sending control commands to said dedicated networked device monitor if said test results meet a specified criteria.

9. The method of claim 8 wherein said step of communicating with said dedicated networked device monitor comprises communicating with said dedicated networked device monitor through a network connection using a control computer, said network connection being a wireless connection, said control computer being a handheld computer.
